(19) United States
(12) Patent Application Publication
(10) Pub. No.: US 2023/0289834 A1
(43) Pub. Date: Sep. 14, 2023

(54) INDUSTRIAL MOMENTUM INDEX

(71) Applicant: Newmark & Company Real Estate, Inc., New York, NY (US)

(72) Inventor: Robert Bach, Oak Hills, IL (US)

(21) Appl. No.: 18/198,919

(22) Filed: May 18, 2023

Related U.S. Application Data
(63) Continuation of application No. 17/487,105, filed on Sep. 28, 2021.
Application No. 17/487,105 is a continuation of application No. 14/857,110, filed on Sep. 17, 2015, now abandoned.
(60) Provisional application No. 62/051,655, filed on Sep. 17, 2014.

(51) Int. Cl. G06Q 30/0202; G06Q 30/0645; G06Q 50/16

(52) U.S. Cl. CPC G06Q 30/0202; G06Q 30/0645; G06Q 50/16

(57) ABSTRACT

A system that comprises retrieving a plurality of factors from a real estate database. Each of the plurality of factors affect a momentum of a real estate market. A statistical model is applied to determine a set of factors that provide a greatest influence on an industrial momentum index. The set of factors are inputted into a formula in order to generate the industrial momentum index. The industrial momentum index is used to predict future real estate activities.

### CROSS-REFERENCED APPLICATIONS

This application is a continuation of U.S. Pat. Application No. 17/487,105 filed Sep. 28, 2021, which is a continuation of U.S. Pat. Application No. 14/857,110 filed Sep. 17, 2015, which claims priority to U.S. Provisional Appl. 62/051,655 filed Sep. 17, 2014, each of which is incorporated by reference herein in its entirety.

### BACKGROUND

Statistical modeling is used in a variety of industries, such as in the pharmaceutical, banking, bio-tech, marketing, and consulting industry, as well as by the government. For example, the pharmaceutical industry may build models to measure the future impact of drugs on the general population. A need arises for creating statistical modeling in the real estate industry.

### BRIEF DESCRIPTION OF THE DRAWINGS

In order to describe the manner in w+hich the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary general-purpose computing device;

FIG. 2 illustrates a flowchart of an industrial momentum index system.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to one skilled in the relevant art and having possession of this disclosure, are to be considered within the scope of the invention claimed.

Those skilled in the art will recognize that the embodiments of the present invention involve both hardware and software elements which portions are described below in such detail required to construct and operate a game method and system according to the embodiments of the present invention.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user’s computer, partly on the user’s computer, as a stand-alone software package, partly on the user’s computer and partly on a remote computer or entirely on a remote computer or server as in a client/server relationship sometimes known as cloud computing. In the latter scenario, the remote computer may be connected to the user’s computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant, wearable technology (such as VR headsets, smart watches, smart glasses, smart rings), or any other machine adapted for executing programmable instructions in accordance with the description thereof set forth above. The embodiments of the present invention may be facilitated by any one of the electronic devices described above.

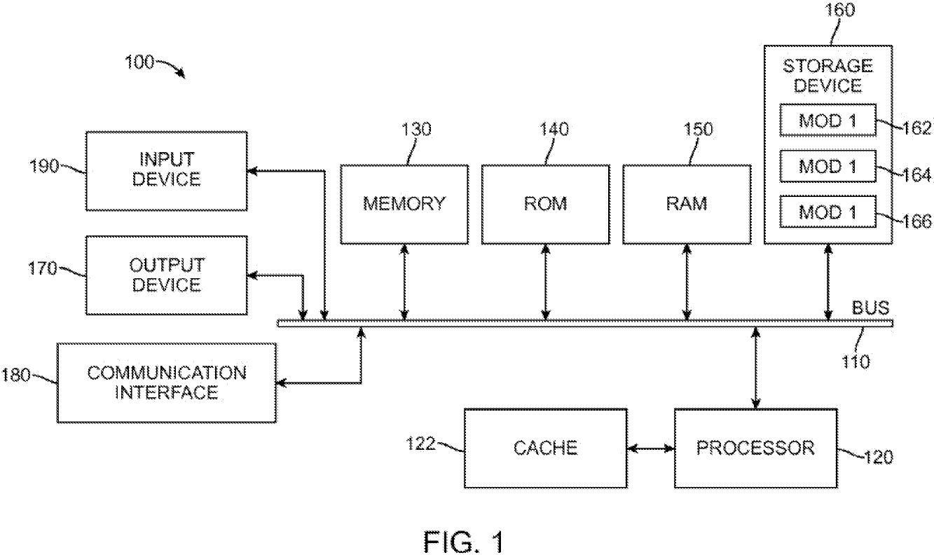

A brief introductory description of a basic general purpose system or computing device in FIG. 1, which can be employed to practice the concepts, is disclosed herein. These variations shall be discussed herein as the various embodiments are set forth. The disclosure now turns to FIG. 1.

With reference to FIG. 1, an exemplary system 400 includes a general-purpose computing device 100, including a processing unit (CPU or processor) 120 and a system bus 110 that couples various system components including the system memory 130 such as read only memory (ROM) 140 and random access memory (RAM) 150 to the processor 120. The system 400 can include a cache 122 of high speed memory connected directly with, in close proximity to, or integrated as part of the processor 120. The system 400 copies data from the memory 130 and/or the storage device 160 to the cache 122 for quick access by the processor 120. In this way, the cache 122 provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multicore processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer readable storage media provide nonvolatile storage of computer readable instructions, data structures, program modules and other data for the computing device 100. In one aspect, a hardware module that performs a particular function includes the software component stored in a non-transitory computer-readable medium in connection with the necessary hardware components, such as the processor 120, bus 110, display 170, and so forth, to carry out the function. The basic components are known to those of skill in the art and appropriate variations are contemplated depending on the type of device, such as whether the computing device 100 is a small, handheld computing device, a desktop computer, or a computer server.

Although the exemplary embodiment described herein employs the hard disk 160, it should be appreciated by those skilled in the art that other types of computer readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example, the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations discussed below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 400 shown in FIG. 1 can practice all or part of the recited methods, can be a part of the recited systems, and/or can operate according to instructions in the recited non-transitory computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored as would be known in the art in other computer-readable memory locations.

### EXEMPLARY INDUSTRIAL MOMENTUM INDEX

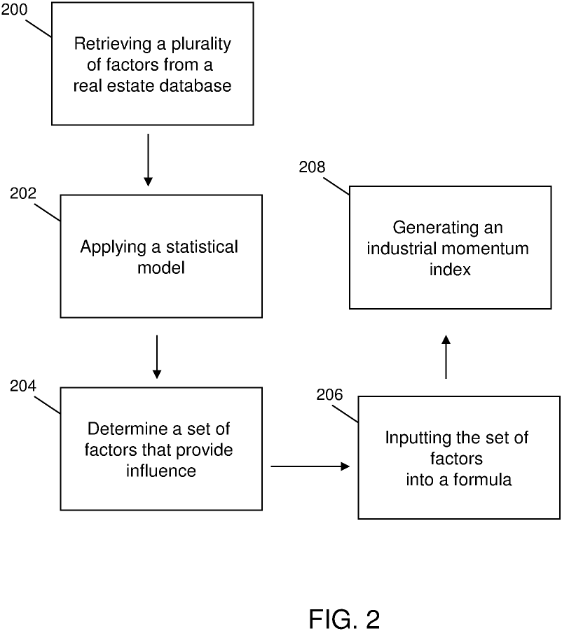

Having disclosed some components of a computing system, the disclosure now turns to FIG. 2, which illustrates a flowchart of the industrial momentum index system. The flowchart comprises step 200 of retrieving a plurality of factors from a real estate database. In one embodiment, each of the plurality of factors affect a momentum of a real estate market. Step 202 comprises applying a statistical model, which then determines 204 a set of factors that provide a greatest influence on an industrial momentum index. In one embodiment, the set of factors comprises a vacancy rate; an occupied space rate; a rental rate and a construction rate. Step 206 comprises inputting the set of factors into a formula, which in turn generates 208 the industrial momentum index. In one embodiment, the industrial momentum index is used to predict future real estate activities.

In one embodiment, the industrial momentum index (IMI) is paired with a statistical model that projects the index forward. The statistical model may rely on any number of relevant macro-economic market factors. Some factors may include industrial production, retail sales, Moody’s Retail Capital Analytics (RCA) index, vacancy rates, construction levels, net absorption, and occupied space.

Each of these factors may affect the overall momentum index. For example, a decrease in vacancy rates may indicate an increase in the real estate momentum. An increase in construction level may indication an increase in the real estate momentum. Likewise, an increase in net absorption and the space occupied also reflects an increase in the momentum.

In one embodiment, the statistical model may utilize Ordinary Least Squares (OLS) to estimate the progression of the selected market factor variables through time. In some embodiments, non-linear variables are adjusted to be linear in the parameters so that OLS could be used.

In one embodiment, a model is generated based on the future projections of the market factors. The model may be capable of forecasting the level of the IMI index in future years. In one example, the model is a Best Linear Unbiased Estimation, which has been adjusted to eliminate variable problems and data problems. In one embodiment, a variable problem comprises severe multicollinearity. In another embodiment, the data problems comprises serial correlation, which is a common issues with time-series data. Another example of a data problem is heteroskedaticity.

In one embodiment, the IMI forecast model utilizes a Gross Domestic Product variable, a net percentage of banks tightening standards for C&I loans to large and middle market firms variable, a total employment variable, an interest rate variable, and finally a custom dummy variable taking into account recessionary periods in the United States. All variables use time-series data provided by Moody’s, taken as far back as needed.

In one embodiment, the first variable in the forecast model, GDP, is an all-encompassing variable that is a function of consumer consumption, industrial production, and net exports -factors that have significant correlations with industrial momentum when utilized separately. However, because of those variables’ collinear relationship in the model they could not all be used simultaneously, and therefore GDP was selected. In the model, which has an adjusted R-squared of 0.977, the GDP variable is significant at the 1% level and has an acceptable VIF value of 2.737 (indicating that there are no severe issues of multicollinearity). A closer look at the correlation tables yield the same conclusion - GDP does not have a severe multicolinear relationship with any of the other independent variables in the model. Finally, the coefficient of the GDP variable has a positive sign, indicating that as GDP increases, the Industrial Momentum Index also increases.

In another embodiment, the second variable in the model is a net percentage of banks tightening standards for C&I loans to large and middle market firms variable. This variable is a crucial indicator of the commercial borrowing market - an integral part of the acquisition and financing of industrial properties. The net percentage of banks tightening variable is significant at the 1% level and has a relatively low VIF value of 2.747. Correlations with all other variables in the model are below 0.8, indicating that there is not an issue of severe multicolinearity. The sign for this variable is negative, meaning that as banks increase tightening standards, the Industrial Momentum Index will decrease. This relationship holds true in reality, as banks tighten their loan standards, money is harder to get for the purchase or lease of industrial space.

In another embodiment, the third variable in the model, total industrial employment, is the aggregation of the three primary calculations of industrial employment (wholesale trade, manufacturing, and transportation/warehouse employment), which are lagging industrial momentum indicators. For that reason, the industrial employment variable is lagged by two quarters to account for the time it takes for industrial firms to expand space after new employees are hired. The total employment variable is significant at the 1% level and has an acceptable VIF value of 3.724. Its correlation coefficient is less than 0.8 with every other variable, confirming that the variable does not have an issue of severe multicollinearity with any other variable in the model. The coefficient sign is positive, indicating that as industrial employment increases, the industrial momentum index also increases.

In another embodiment, the fourth variable in the model, interest rates, is an influential macroeconomic variable that often indicates the strength of the economy and the status of inflation. Higher interest rates generally imply that borrowing money is more difficult and that inflation is high - conditions that would reduce industrial momentum. For that reason, the sign of the variable is negative, indicating that as interest rates rise, industrial momentum declines. The interest rate variable has been manipulated to make it a reciprocal variable (1/interest rates). Theoretically, interest rates can never be negative or zero, therefore the equation for interest rates cannot be linear (linear variables can be negative as often as they can be positive). Consequently, the best fitting line is a reciprocal equation (1/x). The VIF value is 2.150 and the correlation coefficient for interest rates is under 0.8 with every other variable in the model, indicating that there is no severe multicollinearity. The variable is significant at the 1% level.

In another embodiment, the fifth variable in the model is a recession dummy variable that takes into account recessionary periods in the history of the United States. By attributing recessions to a 1 and periods of growth to a 0, the model can account for a different slope observed in recessions compared with normal economic periods. The variable sign is negative, indicating that the momentum index is lower in times of recession. This variable will help develop more accurate index forecasts in the future, as Moody’s data does not forecast future recessions. The variable has a VIF value of 2.190 and its correlation coefficient is less than 0.8 with every other variable in the model, meaning that there is not a problem with severe collinearity. It is significant at the 5% level (more specifically the 3.3% level).

To test the overall significance of the model, the hypothesis is tested so that that the independent variables have a statistically significant impact on the industrial momentum index. In one embodiment, the null hypothesis is as follows:

$$\text{Ho= B1+B2+B3+B4+B5=0}$$

In one embodiment, the overall model is not statistically significant, and consequently cannot create an accurate forecast of the index. As such, an alternative hypothesis is introduced with simply “reject Ho.”

In one embodiment, the degrees of freedom in model are 49 (# of observations - # of independent variables - 1), the number of independent variables is 5 and the Fc values are 2.45 at the 5% level and 3.51 at the 1% level. The model as a whole has an F-ratio of 441.307, which is greater than both values. Therefore, the null hypothesis can be rejected, and the alternative hypothesis can be accepted. As a result, the overall model becomes more statistically significant.

With regards to data problems, in one embodiment, the model for positive serial correlation has been tested. Serial correlation is a problem that is common when using time-series data. In one embodiment, a Durbin-Waton d-test is used to check for pure serial correlation. For example:

$$\text{Ho=} \text{p} \text{0}$$

$$\text{Ha=P > 0}$$

In one embodiment, the Durbin-Watson coefficient is 1.614 for the model. The model has 55 observations and 5 independent variables, meaning that the lower bound d-stat is 1.37 and the upper bound d-stat is 1.77. The d-stat falls within the upper and lower bounds, signifying that the test for serial correlation is inconclusive at the 5% level.

In one embodiment, the system retrieves a plurality of factors from a real estate database. An example of a real estate database may be CoStar. Another example of a real estate database may be Genie. In one embodiment, the data is streamed to the system on a continual basis. In another embodiment, the data is retrieved at periodic times, such as quarterly, monthly, daily, etc... In yet another embodiment, the data is supplied after the system makes an initial request. These request may occur as frequently as dictated by the system.

Each of the plurality of factors affect a momentum of a real estate market. A statistical model is applied to the plurality of factors to generate a set of factors. These set of factors are determined as providing the greatest influence on an industrial momentum index. In one embodiment, the set of factors include: a vacancy rate; an occupied space rate; a rental rate; and a construction rate. In another embodiment, the set of factors include an even greater number of factors, such as the retail sales and industrial production.

In one embodiment, the set of factors is then inputted into a formula in order to generate the industrial momentum index. Such an industrial momentum index may be used to predict future real estate activities.

In one embodiment, the performance of the industrial momentum index in real-time is evaluated on a continual basis. In another embodiment, the performance is evaluated during set periods of time, such as quarterly, monthly, daily, etc... In some instances, the formula is adjusted to further match the performance of the industrial momentum in real-time.

In one embodiment, the system operates on a mobile device. A user may download an app which allows real-time access to the industrial momentum index.

In another embodiment, the system is run on a central server which transmitted the processed data to client servers. Such client servers may be a customer’s workstation. In another embodiment, the client server is a mobile device, such as an iPhone or virtual reality headset. In another embodiment, the processed data is transmitted in an audio format.

### ADDITIONAL EMBODIMENTS

A. A method comprising: retrieving, via a processor, a plurality of factors from a real estate database, in which each of the plurality of factors affect a momentum of a real estate market; applying, via the processor, a statistical model to determine a set of factors that provide a greatest influence on an industrial momentum index, in which the set of factors comprises: a vacancy rate; an occupied space rate; a rental rate; and a construction rate; and inputting, via the processor, the set of factors into a formula in order to generate the industrial momentum index, in which the industrial momentum index is used to predict future real estate activities. A.1. The method of claim A. further comprising: evaluating a performance of the industrial momentum index in real-time; and adjusting the formula to match the performance of the industrial momentum in real-time. A.2. The method of claim A, in which the statistical model is an ordinary least squares model. A.2.1. The method of claim A.2., in which any non-linear parameters are adjusted to be linear parameters. A.3. The method of claim 1, in which the statistical model is a best linear unbiased estimation model.

B. An apparatus comprising: a processor; and a memory, in which the memory stores instructions stored which, when executed by the processor, direct the processor to: retrieve a plurality of factors from a real estate database, in which each of the plurality of factors affect a momentum of a real estate market; apply a statistical model to determine a set of factors that provide a greatest influence on an industrial momentum index, in which the set of factors comprises: a vacancy rate; an occupied space rate; a rental rate; and a construction rate; and input the set of factors into a formula in order to generate the industrial momentum index, in which the industrial momentum index is used to predict future real estate activities. B.1 The apparatus of claim B, in which the memory further stores instructions which, when executed by the processor, direct the processor to: evaluate a performance of the industrial momentum index in real-time; and adjust the formula to match the performance of the industrial momentum in real-time. B.2. The apparatus of claim B, in which the statistical model is an ordinary least squares model. B.2.1. The apparatus of claim B.2, in which any non-linear parameters are adjusted to be linear parameters. B.3. The apparatus of claim B, in which the statistical model is a best linear unbiased estimation model.

C. An article of manufacture comprising: a non-transitory, computer-readable medium, in which the non-transitory, computer-readable medium stores instructions which, when executed by a processor, direct the processor to: retrieve a plurality of factors from a real estate database, in which each of the plurality of factors affect a momentum of a real estate market; apply a statistical model to determine a set of factors that provide a greatest influence on an industrial momentum index, in which the set of factors comprises: a vacancy rate; an occupied space rate; a rental rate; and a construction rate; and input the set of factors into a formula in order to generate the industrial momentum index, in which the industrial momentum index is used to predict future real estate activities. C.1. The non-transitory, computer-readable medium of claim C, in which the non-transitory computer-readable medium further stores instructions which, when executed by the processor, direct the processor to: evaluate a performance of the industrial momentum index in real-time; and adjust the formula to match the performance of the industrial momentum in real-time. C.2. The non-transitory, computer-readable medium of claim C, in which the statistical model is an ordinary least squares model. C.2.1. The non-transitory, computer-readable medium of claim C.2., in which any non-linear parameters are adjusted to be linear parameters. C.3. The non-transitory, computer-readable medium of claim C, in which the statistical model is a best linear unbiased estimation model.

1. (canceled)

2. An electronic device for generating a momentum index, comprising:
communication circuitry;
a memory, storing a preset formula and a preset statistical model, and programming instructions; and
a processor operatively coupled to the memory and the communication circuitry,
wherein the programming instructions are executable by the processor to cause the electronic device to:
transmit a request to an external database, via the communication circuitry, to retrieve a plurality of data factors prestored in the external database,
receive a transmission of the plurality of data factors from the external database,
analyze the plurality of data factors based on at least one model, the at least one model having at least three input variables and being a preset statistical model to predictively identify a subset of data factors from among the plurality of data factors that alter the momentum index by at least a predetermined threshold, and
enter the identified subset of data factors into the preset formula and resolving the preset formula to generate the momentum index.

3. The electronic device of claim 2, wherein the programming instructions are further executable by the processor to:
repeat generation of the momentum index in real-time including continually streaming the plurality of data factors from the external database, re-analyzing the plurality of data factors using the preset statistical model to determine the subset of data factors, and re-entering the subset of data factors into the preset formula to re-generate the momentum index.

4. The electronic device of claim 2, wherein the programming instructions are further executable by the processor to:
repeat generation of the momentum index periodically by detecting whether a preset update period has lapsed; and
based on detecting that the preset update has lapsed, re-request the plurality of data factors from the external database, re-analyzing the plurality of data factors using the preset statistical model to determine the subset of data factors, and re-entering the subset of data factors into the preset formula to re-generate the momentum index after the lapse of the preset update period.

5. The electronic device of claim 2, wherein the preset statistical model includes an ordinary least squares (OLS) regression for predicting progression of variables indicated in the plurality of data factors over time.

6. The electronic device of claim 5, wherein the programming instructions are further executable by the processor to:
generate a momentum index model based on the predicted progression of the variables, wherein the momentum index model utilizes one or more of:
a gross domestic product (GDP) variable, a net percentage indicative of a percentage of banks having a preset lending standard, a total industrial employment, a current interest rate, and a recession dummy variable.

7. The electronic device of claim 2, wherein the momentum index corresponds to economic real-estate data, and plurality of data factors includes one or more of:
a vacancy rate, an occupied space rate, a rental rate, a construction rate, a retail sales level, a precalculated index, and a real estate absorption rate.

8. The electronic device of claim 2, wherein the programming instructions are further executable by the processor to:
detect, via the communication circuitry, a request to download install files of a momentum index app stored in the memory, from an external mobile device;
transmit the install files to the external mobile device; and
transmit the generated momentum index to the external mobile device when the external mobile device operates an instance of the momentum index app installed from the transmitted install files.

9. The electronic device of claim 2, wherein the programming instructions are further executable by the processor to:
detect, via the communication circuitry, a request to display the generated momentum index from one or more client workstations; and
transmit the generated momentum index for display to each of the one or more client workstations in response to the request.

10. A method in an electronic device for generating a momentum index, comprising:
transmitting, via communication circuitry, a request to an external database to retrieve a plurality of data factors prestored in the external database;
receiving a transmission of the plurality of data factors from the external database;
analyzing, via at least one processor, the plurality of data factors based on at least one model, the at least one model having at least three input variables and being a preset statistical model stored in a memory, the preset statistical model to predictively identify a subset of data factors from among the plurality of data factors that alter the momentum index by at least a predetermined threshold; and
generating the momentum index, via the at least one processor, by entering the identified subset of data factors into a preset formula stored in the memory.

11. The method of claim 10, further comprising:
repeating generation of the momentum index in real-time including continually streaming the plurality of data factors from the external database, re-analyzing the plurality of data factors using the preset statistical model to determine the subset of data factors, and re-entering the subset of data factors into the preset formula to re-generate the momentum index.

12. The method of claim 10, further comprising:
repeating generation of the momentum index periodically by detecting whether a preset update period has lapsed; and
based on detecting that the preset update has lapsed, re-requesting the plurality of data factors from the external database, re-analyzing the plurality of data factors using the preset statistical model to determine the subset of data factors, and re-entering the subset of data factors into the preset formula to re-generate the momentum index after the lapse of the preset update period.

13. The method of claim 10, wherein the preset statistical model includes an ordinary least squares (OLS) regression for predicting progression of variables indicated in the plurality of data factors over time.

14. The method of claim 13, further comprising:
generating a momentum index model based on the predicted progression of the variables, wherein the momentum index model utilizes one or more of:
a gross domestic product (GDP) variable, a net percentage indicative of a percentage of banks having a preset lending standard, a total industrial employment, a current interest rate, and a recession dummy variable.

15. The method of claim 10, wherein the momentum index corresponds to economic real-estate data, and plurality of data factors includes one or more of:
a vacancy rate, an occupied space rate, a rental rate, a construction rate, a retail sales level, a precalculated index, and a real estate absorption rate.

16. The method of claim 10, further comprising:
detecting, via the communication circuitry, a request to download install files of a momentum index app stored in the memory, from an external mobile device;
transmitting the install files to the external mobile device; and
transmitting the generated momentum index to the external mobile device when the external mobile device operates an instance of the momentum index app installed from the transmitted install files.

17. The method of claim 10, further comprising:
detecting, via the communication circuitry, a request to display the generated momentum index from one or more client workstations; and
transmitting the generated momentum index for display to each of the one or more client workstations in response to the request.
